(19) United States
(12) Patent Application Publication
(10) Pub. No.: US 2026/0158885 A1
(43) Pub. Date: Jun. 11, 2026

(54) ROOF PANEL ASSEMBLY FOR VEHICLE

(71) Applicants: Hyundai Motor Company, Seoul (KR); Kia Corporation, Seoul (KR)

(72) Inventors: Heng Xu, Yantai (CN); Dong Yue Zhu, Yantai (CN); Xiao He, Yantai (CN); Lei Lei Shan, Yantai (CN)

(21) Appl. No.: 19/410,550

(22) Filed: Dec. 5, 2025

(30) Foreign Application Priority Data
Dec. 6, 2024 (CN) 202411793078.3

(51) Int. Cl. B60J 7/043

(52) U.S. Cl. CPC B60J 7/043

(57) ABSTRACT

A roof panel assembly for a vehicle may include a roof outer panel including a sunroof opening, and a reinforcement assembly disposed below the roof outer panel and including a cross member assembly and a sunroof frame assembly surrounding an edge of the sunroof opening, wherein the sunroof frame assembly includes a rear frame assembly located at a rear of the vehicle, wherein the cross member assembly includes a rear cross member assembly located at a rear of the rear frame assembly, and a connecting member assembly connecting the roof outer panel, the rear cross member assembly, and the rear frame assembly.

### CROSS-REFERENCE TO RELATED APPLICATION

This application claims priority to and the benefit of Chinese Patent Application No. 202411793078.3 filed with the Chinese National Intellectual Property Administration on Dec. 6, 2024, the entire contents of which are incorporated herein by reference.

### TECHNICAL FIELD

The present disclosure relates to a roof panel assembly for a vehicle provided with a sunroof.

### BACKGROUND

With the advancement of vehicle technology and the improvement of living standards, a vehicle provided with a sunroof is receiving increasing attention. Currently, a sunroof has gradually become a standard component in a family vehicle. In particular, recently, considering people's demands for the practicality and aesthetic appearance of the sunroof, and a large-sized sunroof (a panoramic sunroof, an extended sunroof, an elongated sunroof, a length-extended/lengthened sunroof, etc.) is becoming increasingly popular.

However, as the sunroof becomes larger, increasing the strength of the sunroof and its surrounding mounting parts, and solving the performance degradation caused by noise, vibration, and harshness (NVH) problems arising from mounting the sunroof on the roof panel, has become an important task in improving a body structure of the vehicle.

In this regard, according to related art, a reinforcement cross member device for a vehicle's roof panel is disclosed. According to related art, the connection between the roof panel and a side panel is strengthened by welding a reinforcement cross member to a sunroof reinforcement ring and screw-fastening a connecting plate to a reinforcement cross member and a side sheet metal, thereby increasing the stiffness of the roof panel and improving the torsional mode of the roof panel. Therefore, it solves the problem where the roof panel structure with a sunroof affects the NVH performance of the entire vehicle due to weak local stiffness at a rear of the roof panel or insufficient connection support between the roof panel and the side panel.

According to related art, problems existing in the roof structure provided with a sunroof are solved by adding a cross member connecting plate that connects side surfaces of a vehicle body to a rear roof. However, the lack of optimization in the structure consumes too much sheet metal, which can significantly increase the overall cost. Furthermore, how to improve the degradation of the vehicle's NVH performance and the lack of stiffness is also a problem.

The matters described in this background section are written to enhance understanding of the background of the present disclosure and may include matters that are not prior art already publicly known, available, or in use.

### SUMMARY

The present disclosure relates to the field of vehicle technology, and more particularity, the present disclosure relates to a roof panel assembly for a vehicle provided with a sunroof.

An embodiment may provide a roof panel assembly for a vehicle. More specifically, an embodiment of the present disclosure may provide a reinforcing structure for a roof panel assembly for a vehicle used near a rear of the vehicle, which can solve problems of performance degradation and insufficient stiffness caused by NVH problems at a rear of a roof panel of the vehicle equipped with a sunroof, particularly a vehicle equipped with an elongated sunroof (extended sunroof, length-extended/lengthened sunroof, and the like), can improve the overall stiffness of the vehicle roof panel to improve the overall stiffness of the vehicle, and can significantly improve the NVH performance of the vehicle.

A roof panel assembly for a vehicle according to an embodiment of the present disclosure may include: a roof outer panel provided with a sunroof opening; and a reinforcement assembly provided below the roof outer panel and including a cross member assembly and a sunroof frame assembly surrounding an edge of the sunroof opening, wherein the sunroof frame assembly includes a rear frame assembly disposed at a rear portion of the vehicle, the cross member assembly includes a rear cross member assembly disposed at a rear of the rear frame assembly, and the roof panel assembly for the vehicle may further include a connecting member assembly that connects the roof outer panel, the rear cross member assembly, and the rear frame assembly.

The connecting member assembly may include two L-shaped support connecting members, wherein each L-shaped support connecting member may include: a first connecting cross-section disposed at one end of the corresponding L-shaped support connecting member; a second connecting cross-section disposed at the other end of the corresponding L-shaped support connecting member; and a main body disposed between the first connecting cross-section and the second connecting cross-section.

The main body may include a frame connecting surface, wherein the first connecting cross-section may be connected to the roof outer panel, the second connecting cross-section may be connected to the rear cross member assembly of the cross member assembly, and the frame connecting surface of the main body may be connected to the rear frame assembly of the sunroof frame assembly.

The first connecting cross-section may be welded to the roof outer panel, the second connecting cross-section may be bolt-coupled to the rear cross member assembly, and the frame connecting surface may be welded to the rear frame assembly.

The rear cross member assembly may include: a rear upper cross member disposed proximate to the roof outer panel in a height direction of the vehicle; and a rear lower cross member disposed below the rear upper cross member, wherein the second connecting section is connected to the rear upper cross member.

The L-shaped support connecting member may be integrally formed.

A cross-sectional shape of the main body in a thickness direction may be a continuous uneven shape in which grooves and bosses are continuously and alternately arranged along a width direction.

The cross-sectional shape of the main body in the thickness direction may be a shape in which a groove, a boss, and a groove are sequentially arranged along the width direction. A convex surface of the boss may face the roof outer panel and may be spaced apart from the roof outer panel, and an upper chamber may be formed between the roof outer panel and the main body. A bottom surface of the groove may define a frame connecting surface that contacts the rear frame assembly, a convex surface of the boss and the rear frame assembly may be spaced apart from each other, and a lower chamber may be formed between the rear frame assembly and the boss.

A sealer may be provided at a plurality of positions between an edge of the main body in the width direction and the roof outer panel.

The main body may include a first main body portion provided with the frame connecting surface and a second main body portion not provided with the frame connecting surface.

The connecting member assembly may be a fork-shaped connecting member.

The fork-shaped connecting member may include: two parallel connecting plates, each being provided with a connecting cross-section connected to the rear cross member assembly; and a main body connected to one side of each connecting plate opposite to the connecting cross-section and perpendicular to the corresponding connecting plate, wherein the main body may include a first connecting portion connected to the roof outer panel and two second connecting portions connected to the rear frame assembly, and wherein each of the second connecting portions may be located on one side or the other side of the first connecting portion and may be proximate to a lower end of the connecting plate.

The rear frame assembly may include a first rear frame and a second rear frame disposed on both sides of the vehicle in a width direction, and the first rear frame and the second rear frame may be spaced apart from each other, and the fork-shaped connecting member may be mounted between the first rear frame and the second rear frame.

The roof panel assembly for the vehicle may further include two side connecting members, one of the two side connecting members may connect the roof outer panel and the first rear frame on one side of the vehicle in the width direction, and the other of the two side connecting members may connect the roof outer panel and the second rear frame on the other side of the vehicle in the width direction.

The fork-shaped connecting member may be integrally formed.

A sealer may be provided at a plurality of positions between an edge of the connecting member assembly and the roof outer panel.

The connecting member assembly may be a sheet metal structural member.

According to some embodiments of the present disclosure, it is possible to solve problems of performance degradation and insufficient stiffness caused by the NVH problem at the rear of the roof panel of the vehicle equipped with the sunroof, particularly the vehicle equipped with the elongated sunroof (extended sunroof, length-extended/lengthened sunroof, and the like).

According to some embodiments of the present disclosure, it is possible to improve the overall stiffness of the vehicle roof panel to improve the overall stiffness of the vehicle, and to significantly improve the NVH performance of the vehicle.

Other advantages that can be obtained or are anticipated due to the example embodiments of the present disclosure may be directly or implicitly disclosed in the detailed description of the example embodiments of the present disclosure. That is, various advantages anticipated according to the example embodiments of the present disclosure will be disclosed within the detailed description to be described later.

### BRIEF DESCRIPTION OF THE DRAWINGS

FIG. 1 is a schematic perspective view of a roof panel assembly for a vehicle according to an example embodiment of the present disclosure.

FIG. 2 is a schematic top plan view of a roof panel assembly for a vehicle according to an example embodiment of the present disclosure.

FIG. 3 is a schematic top plan view of a rear portion of a roof panel assembly for a vehicle according to an example embodiment of the present disclosure.

FIG. 4 is a schematic partially enlarged view of a portion where a connecting member assembly of FIG. 3 is located.

FIG. 5 is a schematic top plan view of an L-shaped support connecting member of a connecting member assembly according to an example embodiment of the present disclosure.

FIG. 6 is a perspective view of an L-shaped support connecting member of a connecting member assembly according to an example embodiment of the present disclosure.

FIG. 7 is a cross-sectional view taken along line A-A of FIG. 6.

FIG. 8 is a cross-sectional view taken along line D-D of FIG. 4.

FIG. 9 is a schematic view of a rear portion of a roof panel assembly for a vehicle according to another example embodiment of the present disclosure.

FIG. 10 is a schematic enlarged view of a portion related to the connecting member assembly in FIG. 9 (the portion in the square box of FIG. 9).

FIG. 11 is a schematic diagram showing a structure of a roof panel of a vehicle of a prior art.

FIG. 12 is a graph comparing CAE results of a specific example embodiment of the present disclosure and the structure of the prior art.

FIG. 13 is a schematic perspective view of an entire frame of a vehicle incorporating a roof panel assembly according to an example embodiment of the present disclosure.

It should be understood that elements shown in the drawings are not necessarily drawn to scale for simplicity and/or clarity of the drawings. For example, the dimensions of some elements may be exaggerated relative to other elements for clarity. Furthermore, known components may have been omitted in the drawings of example embodiments to more easily explain the concepts of the present disclosure. The sizes of the drawings do not necessarily represent the exact sizes and/or ratios of the various elements depicted herein.

### DETAILED DESCRIPTION OF ILLUSTRATIVE EMBODIMENTS

Hereinafter, some example embodiments of the present disclosure will be described in detail with reference to the accompanying drawings. It should be understood that the various specific embodiments described herein are merely illustrative examples for a complete description and do not necessarily limit the protection scopes of the present disclosure. All other embodiments obtained by those skilled in the art based on the specific example embodiments of the present disclosure without creative labor all fall within the protection scopes of the present disclosure.

Some specific details may be described below. However, an embodiment described herein may be practiced without specific details. In a specific example embodiment, to avoid obscuring the content, detailed descriptions of a known structure and technology may have been omitted.

It should be understood that in this specification, elements may be referred to by ordinal adjectives such as “first,” “second,” “third,” and the like, and unless explicitly stated, this may be used to distinguish between different elements and does not necessarily imply that the mentioned elements follow a given order in time, space, or any other manner.

Furthermore, for convenience of description, directional terms such as “up,” “down,” “left,” “right,” “horizontal,” “vertical,” “front,” “rear,” “upper,” “bottom,” “inner,” “outer,” and the like have been used below, but this may only limit the relative positional relationship between each member in a specific posture as shown in the drawings. Accordingly, the use of these directional terms does not necessarily limit the configuration of the member, and if the corresponding specific posture is changed, the terms indicating direction may be changed accordingly.

In this specification, unless otherwise specified, “connection,” “fixing,” and the like may be understood in a broad sense unless there is a special explanation. For example, “fixing” may include a fixed connection or a detachable connection, or being integrally formed, and “connection” may include a mechanical connection or an electrical connection, and may include a direct connection or an indirect connection through an intermediate medium. In this specification, “up-down direction,” “front-rear direction,” “left-right direction,” “width direction,” “length direction,” “parallel,” and “vertical” are not limited to the strict geometric directions (up-down, front-rear, left-right, parallel, and vertical), and for example, also include cases of being slightly inclined at a certain angle to the geometric direction.

Furthermore, it may be further understood that in this specification, the words “approximately” or “about” may be used to modify values, which indicates that they are within the normal tolerance range in the relevant field.

The content shown in the accompanying drawings is schematically illustrated and does not necessarily represent the structure of the actual product. For convenience of description and better understanding, the proportions of each component may not necessarily correspond to the actual product.

For better understanding and ease of description, a three-dimensional coordinate system (XYZ coordinate system) or a planar Cartesian coordinate system (XY coordinate system/YZ coordinate system) may be indicated in this specification, and a positive direction and a negative direction may be indicated for each axis of XYZ. However, these coordinate systems and the positive and negative directions are indicated in the drawings for convenience of understanding, and the structure of each drawing does not necessarily need to satisfy the coordinate and direction-related requirements of the corresponding coordinate system.

Hereinafter, a roof panel assembly for a vehicle of some example embodiments of the present disclosure will be specifically described.

### First Example Embodiment

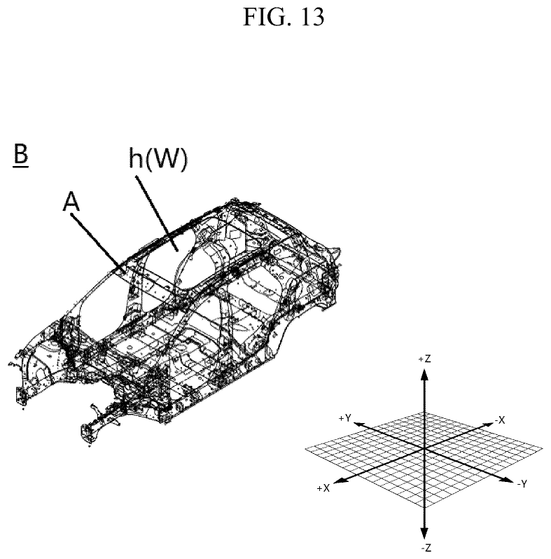

Regarding the overall basic structure of a vehicle frame, refer to the schematic perspective view of a vehicle frame B, which is an entire vehicle frame shown in FIG. 13. To aid in understanding the description, in the following description, the X-axis direction in the XYZ spatial Cartesian coordinate system is referred to as a longitudinal direction (or front-rear direction) of the vehicle. In this example, a forward direction of the vehicle is referred to as a front, and a backward direction of the vehicle is referred to as a rear. The Y-axis direction is referred to as a width direction (or left-right direction) of the vehicle, and the Z-axis direction is referred to as a height direction (or up-down direction/vertical direction) of the vehicle. In some examples, “+” and “−” may be indicated for the XYZ directions, respectively, but this is for understanding the structure of the present disclosure and does not limit the present disclosure. There are also examples where it is not necessary to indicate positive and negative signs for the XYZ directions.

As shown in FIG. 13, the vehicle frame B is provided with a roof panel assembly A for a vehicle, the vehicle roof panel assembly A is mounted on an upper portion of the vehicle frame B, and a sunroof W is mounted on the vehicle roof panel assembly A.

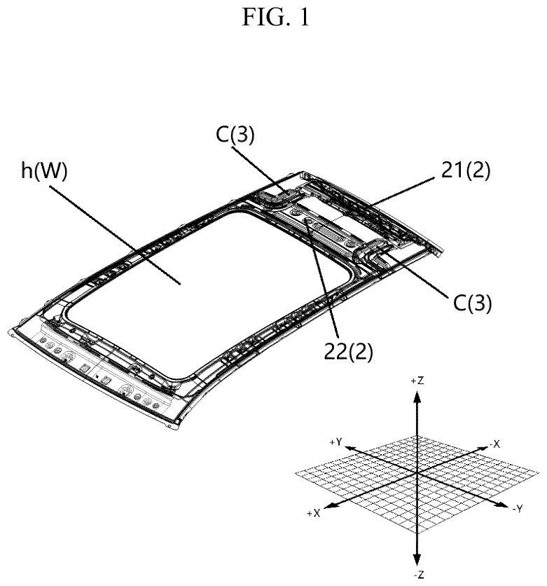

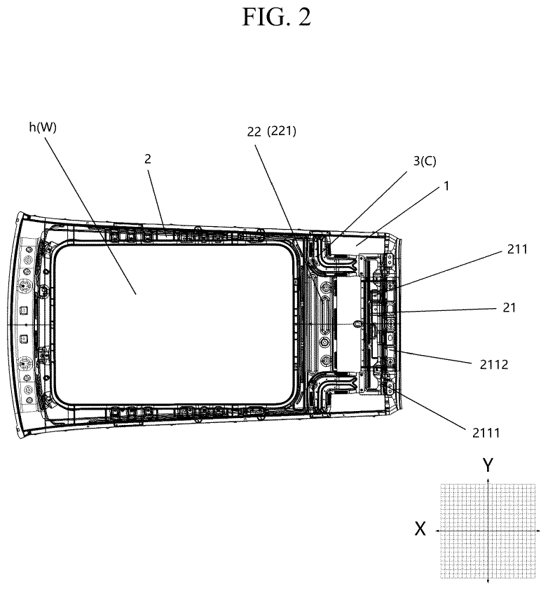

As shown in FIG. 1 and FIG. 2, the vehicle roof panel assembly A mainly includes a roof outer panel 1 in which a sunroof opening h for mounting the sunroof W of the vehicle is formed; and a reinforcement assembly 2 provided below the roof outer panel 1 to provide support reinforcement and stiffness improvement for the roof outer panel 1. In an example, the reinforcement assembly 2 includes a cross member assembly 21 and a sunroof frame assembly 22 surrounding an edge of the sunroof opening h. In some embodiments, the reinforcement assembly 2 may further include other members or a reinforcing member.

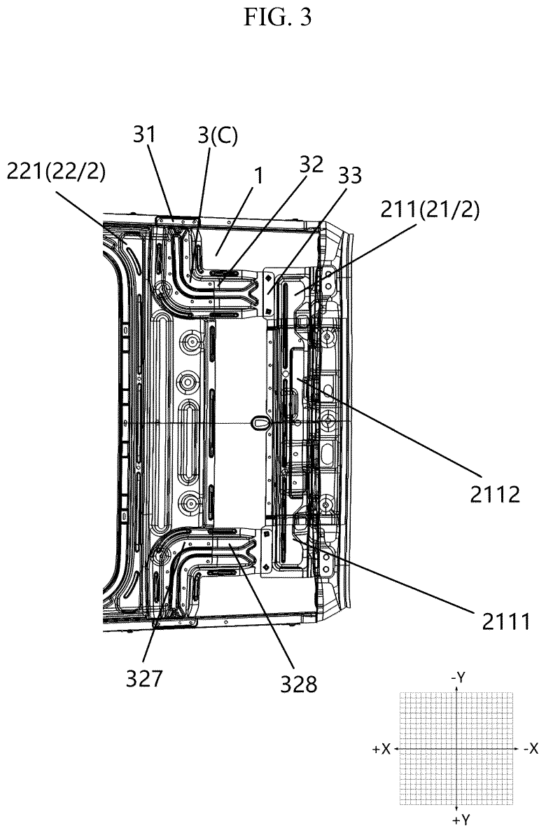

As shown in FIG. 2 and FIG. 3, the cross member assembly 21 includes at least a rear cross member assembly 211 located at a rear of the vehicle with respect to the front-rear direction of the vehicle (X direction in the drawing). As shown in FIG. 2 to FIG. 4, the rear cross member assembly 211, for example, may include a rear upper cross member 2111 installed proximate to the roof outer panel 1 in the up-down direction (a height direction of the vehicle, which is the Z direction in FIG. 13) and a rear lower cross member 2112 installed below the rear upper cross member 2111, but is not necessarily limited thereto. For example, in some embodiments, the rear cross member assembly 211 may include other cross member structures.

In some embodiments, in addition to the rear cross member assembly 211, the cross member assembly 21 may further include other parts. For example, the cross member assembly 21 may further include other cross member assemblies such as a front cross member assembly located at a front in the front-rear direction of the vehicle (X direction in the drawing) and a middle cross member assembly located in a central portion, or a reinforcing member. However, because the example embodiment of the present disclosure mainly relates to solving an NVH problem at the rear of the sunroof W, a part located at the rear of the vehicle roof panel assembly A is specifically described, and detailed descriptions of other parts are omitted. However, embodiments of the present disclosure are not necessarily limited to those examples specifically described herein, and may also include other members (e.g., as long as it can ensure the torsional stiffness of the frame and the stability to withstand internal and external forces such as a longitudinal load, and can provide support reinforcement for the main members of the vehicle).

In some embodiments, as shown in FIG. 2 and FIG. 3, for example, the sunroof frame assembly 22 is provided with at least a rear frame assembly 221 located at a rear with respect to the front-rear direction of the vehicle (the longitudinal direction of the vehicle, which is the X direction in the drawing). The sunroof frame assembly 22 may further include a front frame assembly located at the front in the front-rear direction of the vehicle, side frame assemblies located on both sides in the width direction of the vehicle (the left-right direction, which is the Y direction in the drawing), and/or other reinforcing members, and the like. As in the example of the cross member assembly 21, because the example embodiment of the present disclosure mainly relates to solving the NVH problem at the rear of the sunroof W, a rear portion of the vehicle roof panel assembly A is mainly described in detail here, and a description of other parts is omitted. Of course, the vehicle roof panel assembly A may also include other members as long as it can support and fix the sunroof and ensure the safety of the vehicle body.

In some embodiments, the term “assembly” may be understood as an independent member (e.g., a sheet metal member or an integrally molded member), may mean a combination of a plurality of members (e.g., through welding, threading, riveting, etc.), and may also mean a member made non-flat with unevenness or shapes on its surface by stamping or forging. Therefore, what the term “assembly” means is not particularly limited.

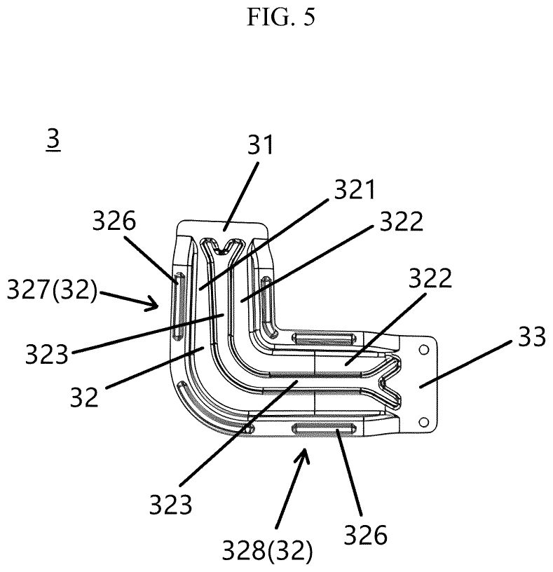

As shown in FIG. 1 to FIG. 6, in some embodiments, the vehicle roof panel assembly A further includes a connecting member assembly C that connects the roof outer panel 1, the rear cross member assembly 21, and the sunroof frame assembly 22. More specifically, as shown in FIG. 3 to FIG. 5, for example, the connecting member assembly C may include two L-shaped support connecting members 3 that are L-shaped overall. The L-shaped support connecting member 3 may be connected to the roof outer panel 1 and the rear cross member assembly 211 of the cross member assembly 21 and the rear frame assembly 221 of the sunroof frame assembly 22.

As shown in FIG. 2 to FIG. 8, in some embodiments, the L-shaped support connecting member 3 may be L-shaped overall and may be provided with a first connecting cross-section 31, a second connecting cross-section 33, and a main body 32 disposed between the first connecting cross-section 31 and the second connecting cross-section 33. In some embodiments, the L-shaped support connecting member 3 may include one end and the other end according to its L-shaped outline, one end and the other end of the L-shaped support connecting member 3 may be referred to as a first connecting cross-section 31 and a second connecting cross-section 33, respectively, and a portion between the first connecting cross-section 31 and the second connecting cross-section 33 may be referred to as a main body 32. For example, the first connecting cross-section 31 may be connected to the roof outer panel 1, the second connecting cross-section 33 may be connected to the rear cross member assembly 211, and the main body 32 may be connected to the rear frame assembly 221.

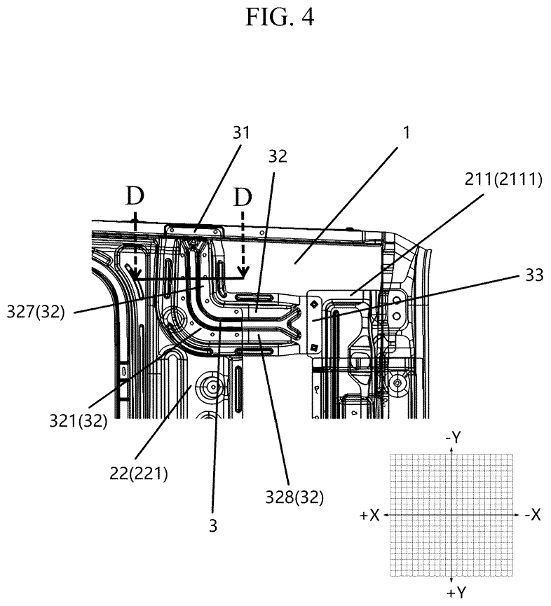

In one specific example, as shown in FIG. 4, the first connecting cross-section 31 of the L-shaped support connecting member 3 may be connected to a lower side (lower surface) of the roof outer panel 1 by, for example, welding, a second connecting cross-section 33 of the L-shaped support connecting member 3 may be connected to the rear cross member assembly 211 (more specifically, the rear upper cross member 2111) by, for example, bold coupling (screw-fastening and the like), and a portion of the main body 32 of the L-shaped support connecting member 3 that is located on an upper surface side (upper side in the Z direction, i.e. up-down direction) of the rear frame assembly 221 of the sunroof frame assembly 22 and overlaps the rear frame assembly 221 may be connected to the rear frame assembly 221 by welding or the like. In this way, a portion of the sunroof W (the vehicle roof panel assembly A) located at the rear of the vehicle may be directly or indirectly connected to the roof outer panel 1, the rear frame assembly 221, and the rear cross member assembly 211 by the L-shaped support connecting member 3.

For better understanding and ease of description, one surface of the main body 32 that is connected to the upper surface side of the rear frame assembly 221 may also be referred to as a frame connecting surface 321 (see FIG. 4 to FIG. 8). In some embodiments, with the L-shaped bend as a boundary, a portion of the main body 32 provided with the frame connecting surface 321 (i.e., the portion where the frame connecting surface 321 of the main body 32 is located) may be referred to as a first main body portion 327, and a portion of the main body 32 not provided with the frame connecting surface 321 may be referred to as a second main body portion 328. The distinction between the first main body portion 327 and the second main body portion 328 does not necessarily mean a physical (substantive) distinction, but may also be a virtual distinction. For example, when the L-shaped support connecting member 3 is formed, a portion of the main body 32 provided with the frame connecting surface 321 may be referred to as the first main body portion 327.

In some embodiments, the connection method of the L-shaped support connecting member 3 with the roof outer panel 1, the rear frame assembly 221, and the rear cross member assembly 211 is merely an example, and embodiments of the present disclosure are not limited thereto, and another connection method may be adopted. In some embodiments, considering the convenience and stability of connection between members, and possible NVH problems, the L-shaped support connecting member 3 may be connected to the roof outer panel 1 and the rear frame assembly 221 by welding, and the L-shaped support connecting member 3 may be coupled to the rear cross member assembly 211 with bolts or screws.

In some embodiments, the L-shaped support connecting member 3 has a plate shape overall, may be integrally molded, and may have a structure of a sheet metal member, and various shapes and structures may be formed on its upper surface by a method such as stamping molding or molding. In such example, a plate-shaped or plate material member and the like does not necessarily mean that the member has a flat plate shape with a flat surface, but may also be a plate material having various patterns or shapes on its surface (for example, various patterns or shapes formed by stamping, forging, mold molding).

In some embodiments, as shown in FIG. 3 and FIG. 4, for example, the rear cross member assembly 211 includes the rear upper cross member 2111 installed proximate to the roof outer panel 1 in a height direction Z of the vehicle and the rear lower cross member 2112 located on a lower side of the rear upper cross member 2111 in the height direction Z and overlapping (or partially overlapping) the rear upper cross member 2111. The second connecting cross-section 33 of the L-shaped support connecting member 3 may be connected to the rear upper cross member 2111 of the rear cross member assembly 211, but embodiments of the present disclosure are not limited thereto, and may be connected to another position of the rear cross member assembly 211, or may be connected to the rear upper cross member 2111 through another member.

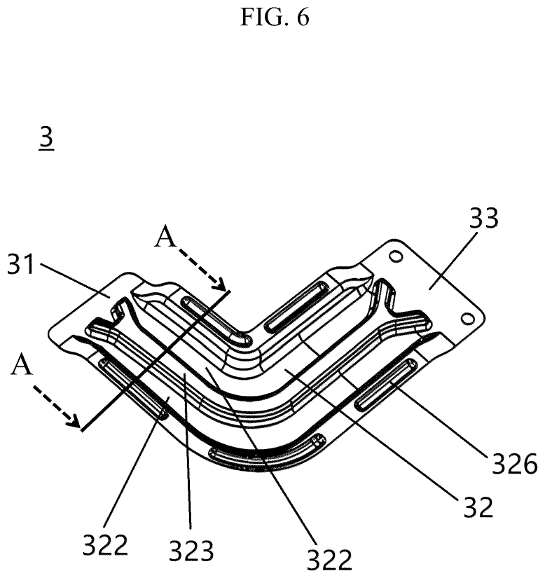

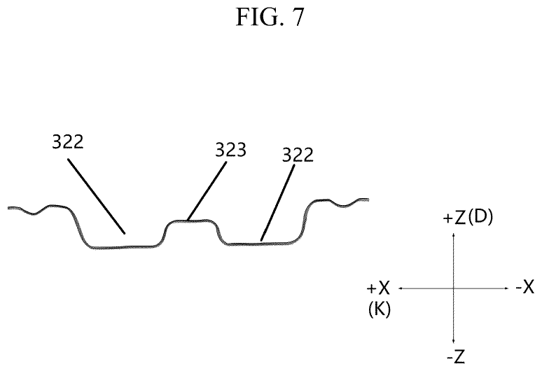

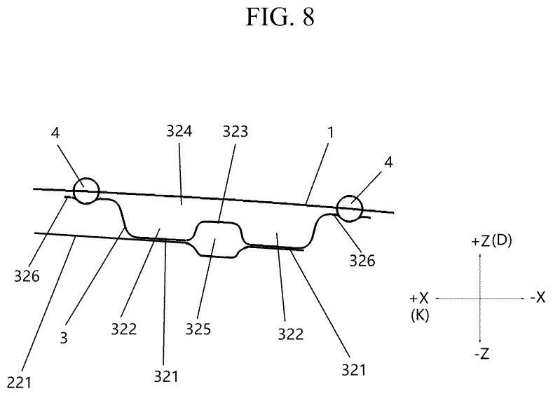

Hereinafter, a cross-sectional shape of the L-shape support connecting member 3 in a thickness direction D (up-down vertical direction Z/height direction) will be described. FIG. 6 is a schematic perspective view of a L-shape support connecting member 3 according to an example embodiment. FIG. 7 is a cross-sectional view of the main body 32 of the L-shaped support connecting member 3 in the thickness direction D (for example, a cross-sectional view taken along line A-A of FIG. 6), and FIG. 8 is a cross-sectional view of the L-shaped support connecting member 3 in a state of being mounted on the roof outer panel 1 in the thickness direction D.

As shown in FIG. 6, a surface of the L-shaped support connecting member 3 may be formed with an uneven, jagged shape (a shape with high and low undulations) by processing such as stamping, forging, or mold molding. As one specific example, a shape of a cross-section of the main body 32 of the L-shaped support connecting member 3 in the thickness direction D (a cross-section taken along line A-A of FIG. 6) may be a continuous uneven shape in which grooves 322 and bosses 323 are continuously and alternately arranged along a width direction K.

More specifically, as shown in FIG. 6 and FIG. 7, the surface of the main body 32 of the L-shaped support connecting member 3 can be referred to as a so-called Y-shaped rigid forming, and the shape of the cross-section of the main body 32 of the L-shaped support connecting member 3 in the thickness direction D may be a shape in which a groove 322, a boss 323, and a groove 322 are sequentially arranged along the width direction K of the L-shaped support connecting member 3.

Here, “a cross-section of the main body 32 of the L-shaped support connecting member 3 in the thickness direction D” means a cross-section of a part obtained by cutting the first main body portion 327 of the main body 32 using a cross-section along the thickness direction D approximately parallel to the first connecting cross-section 31, or a cross-section of a part obtained by cutting the second main body portion 328 of the main body 32 using a cross-section along the thickness direction D approximately parallel to the second connecting cross-section 33, for example. That is, the cross-section in the thickness direction D of the main body 32 of the L-shaped support connecting member 3 does not necessarily have to be a cross-section at one fixed position, but may vary depending on the position of the L-shaped support connecting member 3 of the main body 32. When the first main body portion 327 is cut, the cross-section is parallel to the first connecting cross-section 31, and when the second main body portion 328 is cut, the cross-section is parallel to the second connecting cross-section 33.

In some embodiments, as described above, the cross-sectional shape of the main body 32 in the thickness direction D includes two grooves 322 and one boss 323, but embodiments of the present disclosure are not limited thereto, and various design changes are possible as needed.

In some embodiments, in a state where the L-shaped support connecting member 3 is mounted on the roof outer panel 1, as shown in FIG. 8, a convex surface (protruding surface) of the boss 323 faces the roof outer panel 1 and maintains a predetermined gap therewith such that an upper chamber 324 is formed between the roof outer panel 1 and the main body 32. In some embodiments, a bottom surface of the groove 322 (a bottom portion of the groove 322) contacts the rear frame assembly 221 to form a frame connecting surface 321 (i.e., a welding surface). In this example, the convex surface of the boss 323 is spaced a predetermined distance from the rear frame assembly 221, and a lower chamber 325 is formed between the rear frame assembly 221 and the boss 323.

By comprehensively considering the support performance and structural stiffness of each member, the upper chamber 324 may be formed between the roof outer panel 1 and the main body 32, and the lower chamber 325 may be formed between the rear frame assembly 221 and the boss 323 of the main body 32, thereby effectively resisting deformation of the L-shaped support connecting member in an L direction (a direction along the shape of the L-shaped support connecting member), improving the support strength in the L direction, and improving the NVH performance at the rear of the sunroof.

In some embodiments, as shown in FIG. 8, a sealer 4 may be further provided at a plurality of positions between an edge 326 in a width direction K of the main body 32 (in this example, the width direction K is not the width direction Y of the vehicle, but means the width direction of the main body 32 itself) and the roof outer panel 1. For example, by performing mechanical processing such as sheet metal processing or stamping processing on the edge 326 in the width direction K of the L-shaped support connecting member 3 to form a space for accommodating the sealer 4 (for example, forming a recess or the like on the edge 326), sealing may be implemented by injecting the sealer 4 therein.

For example, the cross-sectional shape of the cross-section of the main body 32 in the thickness direction D may be provided with two grooves 322 and one boss 323, and the bottom surface of the groove 322 (the bottom portion of the groove 322) may contact the rear frame assembly 221 to form the frame connecting surface 321 (i.e., a welding surface). However, the cross-sectional shape of the cross-section of the main body 32 in the thickness direction D is not necessarily limited thereto, and the concave shape and the convex shape may be interchanged.

Next, the main actions of some example embodiments of the present disclosure will be described with reference to the example embodiment of the present disclosure.

As described above, according to market demand, the number of vehicles using a large sunroof (for example, a panoramic sunroof, an extended sunroof, an elongated sunroof, a length-extended/lengthened sunroof, and the like) is increasing. In an actual vehicle testing stage, a roof panel of a vehicle may have NVH and vibration sensitivity problem (the current standard vibration sensitivity is 124 dB or less).

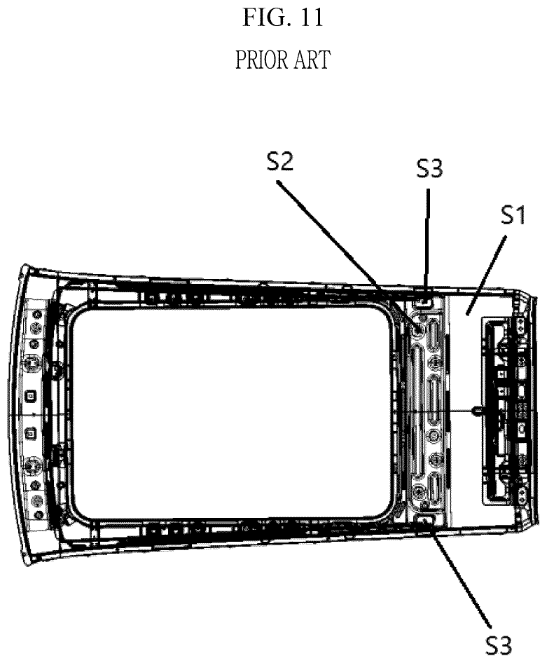

According to the prior art (for example, see FIG. 11), in the case of a structure where a reinforcement cross member is welded to a sunroof reinforcement ring, and a connecting plate is screw-coupled to the reinforcement cross member and a side sheet metal to strengthen the connection between a roof panel and a side panel, there may be a lack of stiff fastening (transverse direction) supporting from the side, resulting in a lack of shear stress. The lack of stiff support of the rear frame assembly (vertical direction) may cause a lack of stiffness in the rear roof structure. In a road durability test, the roof panel of the vehicle lacked transverse coupling force, which weakened the resistance to vertical deformation, causing a rebound phenomenon. According to a result of analysis of vibration sensitivity of finished vehicle (CAE) analysis, it may be seen that in a low-frequency vibration band (1000 to 1100 rpm band), the vertical vibration amplitude is too large.

Some embodiments of the present disclosure may improve NVH performance and improve stiffness by increasing the thickness of the sunroof frame assembly, especially the rear frame assembly, and improving the structure of the connecting member assembly. Specifically, by using an L-shaped support connecting member to directly or indirectly connect the roof outer panel, the rear frame assembly, and the rear cross member assembly, the transverse shear stress is improved, and by using the structural and functional assembly of the L-shaped support connecting member to handle NVH problems, the transverse coupling force and the resistance to vertical deformation are increased to reduce a noise problem and improve stiffness.

An embodiment of the present disclosure can reduce the number of molds, investment costs, inspection, jigs, and welding processes by using the L-shaped support connecting member, compared to the case of an integrated structure.

An embodiment of the present disclosure can strengthen the stiffness, improve the overall stress transfer fluidity, and improve the side connection support performance and the rear connection performance by using the L-shaped support connecting member.

In some embodiments, when forming a tool hole or positioning a hole and an assembly hole, considering the assembly performance of the L-shaped support connecting member, the bracket performance was improved by adding a Y-shaped rigid structure.

In some embodiments, when connecting the L-shaped support connecting member to the roof outer panel, the rear frame assembly, and the rear cross member assembly directly or indirectly, different connection methods were used in different parts. In some embodiments, considering the marketability of the appearance, the support performance and structural stiffness can be effectively improved by connecting the edge of the main body of the L-shaped support connecting member and the roof outer panel using a sealant fastening method instead of a welding/bolt connection method. In some embodiments, in the example of one L-shaped support connecting member, as shown in FIG. 4 to FIG. 8, four parts were fastened using a sealant, but this is merely an example, and the number of fastening parts may be set as needed.

In some embodiments, considering the support performance and structural stiffness, the upper chamber and the lower chamber may be further provided in the assembled overall structure, the upper chamber may be formed by the L-shaped support connecting member and the roof outer panel, and the lower chamber may be formed by the L-shaped support connecting member and the rear frame assembly of the sunroof frame assembly, thereby effectively resisting the L-direction deformation of the L-shaped support connecting member and improving the support strength in the L direction. Therefore, the NVH performance at the rear of the sunroof can be improved.

By connecting the L-shaped support connecting member and other members by the bolt/sealing/welding method, the rear roof outer panel, the rear frame assembly, the rear cross member assembly, and the L-shaped support connecting member form a closed structure, thereby improving the shear stress, increasing the transverse tension under the rear cross member assembly, and improving the NVH problem. By connecting the L-shaped support connecting member between the rear frame assembly and the rear cross member assembly (rear upper cross member), the stiffness of the unconnected area was improved, thereby improving the vertical vibration problem.

### Second Example Embodiment

Next, a second example embodiment of the present disclosure will be described.

In a second example embodiment, the same reference numerals are designated to the same members as in the first example embodiment, and their descriptions are omitted, and only the differences will be described.

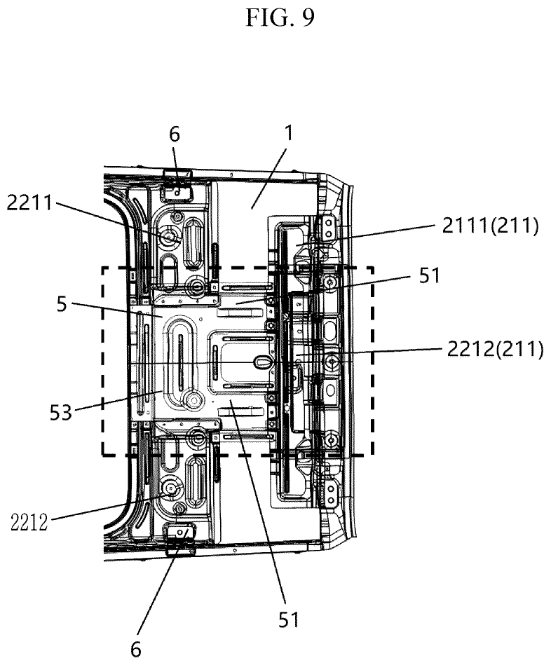

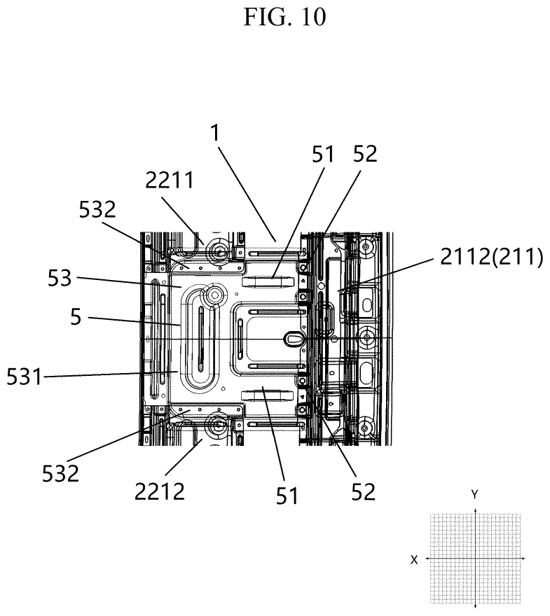

As shown in FIG. 9 and FIG. 10, in the second embodiment, a rear frame assembly 221 is divided into a first rear frame 2211 and a second rear frame 2212, and the first rear frame 2211 and the second rear frame 2212 are not connected and are spaced apart by a predetermined gap. Specifically, the rear frame assembly 221 according to this embodiment is formed of a first rear frame 2211 and a second rear frame 2212 located on both sides in a width direction Y of the vehicle, and the first rear frame 2211 and the second rear frame 2212 are not directly connected and are spaced apart by a predetermined gap.

In some embodiments, a fork-shaped connecting member 5 is further provided between the first rear frame 2211 and the second rear frame 2212.

As shown in FIG. 9 and FIG. 10, the fork-shaped connecting member 5 includes two mutually parallel connecting plates 51 provided with a connecting cross-section 52 connected to the rear cross member assembly 211, and a main body 53 connected to a side opposite to the connecting cross-section 52 of the connecting plate 51 and approximately perpendicular to the connecting plate 51, for example. In other words, as shown in FIG. 9 and FIG. 10, the fork-shaped connecting member 5 is provided with two connecting plates 51 parallel in the Y direction, each connecting plate 51 is provided with the connecting cross-section 52 connected to the rear cross member assembly 211, and the main body 53 is perpendicularly connected to one end opposite to the connecting cross-section 52 of the connecting plate 51, and the approximate shape is a fork shape with two protruding ends, for example.

The main body 53 may include a first connecting portion 531 connected to the roof outer panel 1 and a second connecting portion 532 connected to the rear frame assembly (the first rear frame 2211 and the second rear frame 2212). In the present embodiment, there are two second connecting portions 532, each located on both sides of the first connecting portion 531 and proximate to one end opposite to the connecting cross-section 52 of the connecting plate 51 (for example, see FIG. 10).

In some embodiments, as shown in FIG. 9 and FIG. 10, a roof panel assembly A for a vehicle of the present embodiment further includes two side connecting members 6. One of the two side connecting members 6 connects a roof outer panel 1 and the first rear frame 2211 on one side (upper side of FIG. 9) in the width direction Y of the vehicle, and the other of the two side connecting members 6 connects the roof outer panel 1 and the second rear frame 2212 on the other side (lower side of FIG. 9) in the width direction Y of the vehicle.

In some embodiments, the fork-shaped connecting member 5 of the present embodiment may be integrally formed. In some embodiments, a sealer may be provided at a plurality of positions between an edge of the connecting member assembly C and the roof outer panel 1. In some embodiments, the fork-shaped connecting member 5 of the present embodiment may be a sheet metal structural member.

According to a CAE analysis result, it may be seen that the second embodiment also satisfies the performance requirements and can reach the test standards. The second embodiment can improve the performance of a middle portion of the rear of the vehicle of the roof panel assembly for a vehicle, and compared to the existing structure, it can reduce a mold size of the rear frame assembly and can directly improve the stiffness of the area where the NVH problem occurs.

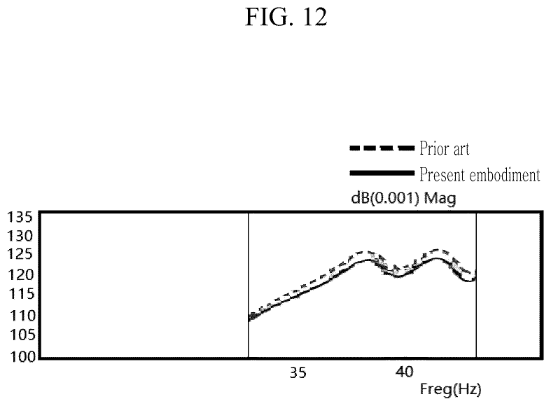

The embodiment of the present disclosure was compared with the prior art (referring to FIG. 11, a side surface of a roof outer panel S1 and a sunroof frame S2 were connected using a connecting member S3). For example, for a comparison of the CAE result of the first embodiment and the prior art (see FIG. 11), reference may be made to FIG. 12.

Referring to the comparison result, it can be seen that both the first embodiment shown in FIG. 3 and the second embodiment shown in FIG. 9 can effectively solve the NVH problem. Therefore, both the first and second embodiments can solve the problems of performance degradation and insufficient stiffness due to NVH that appear at the rear of the roof panel of a vehicle equipped with a sunroof, especially the roof panel of an extended sunroof.

Although the example embodiments of the present disclosure have been described above, the present disclosure is not limited to the above-described embodiments, and includes all modifications within a range that can be easily changed by a person of ordinary skill in the art to which the present disclosure pertains from the embodiments of the present disclosure and are recognized as equivalent.

What is claimed is:

1. A roof panel assembly for a vehicle, comprising:
a roof outer panel including a sunroof opening;
a reinforcement assembly disposed below the roof outer panel and including a cross member assembly and a sunroof frame assembly surrounding an edge of the sunroof opening,
wherein the sunroof frame assembly includes a rear frame assembly disposed at a rear portion of the vehicle,
wherein the cross member assembly includes a rear cross member assembly disposed at a rear of the rear frame assembly; and
a connecting member assembly connecting the roof outer panel, the rear cross member assembly, and the rear frame assembly.

2. The roof panel assembly of claim 1, wherein the connecting member assembly includes two L-shaped support connecting members, and
wherein each of the L-shaped support connecting members includes:
a first connecting cross-section disposed at a first end of the corresponding L-shaped support connecting member;
a second connecting cross-section disposed at a second end of the corresponding L-shaped support connecting member; and
a main body disposed between the first connecting cross-section and the second connecting cross-section.

3. The roof panel assembly of claim 2, wherein the main body includes a frame connecting surface, and
wherein the first connecting cross-section is connected to the roof outer panel,
wherein the second connecting cross-section is connected to the rear cross member assembly of the cross member assembly, and
wherein the frame connecting surface of the main body is connected to the rear frame assembly of the sunroof frame assembly.

4. The roof panel assembly of claim 3, wherein:
the first connecting cross-section is welded to the roof outer panel,
the second connecting cross-section is bolt-coupled to the rear cross member assembly, and
the frame connecting surface is welded to the rear frame assembly.

5. The roof panel assembly of claim 3, wherein the rear cross member assembly comprises:
a rear upper cross member disposed proximate to the roof outer panel in a height direction of the vehicle; and
a rear lower cross member disposed below the rear upper cross member, and
wherein the second connecting cross-section is connected to the rear upper cross member.

6. The roof panel assembly of claim 2, wherein each of the L-shaped support connecting members is integrally formed.

7. The roof panel assembly of claim 2, wherein a cross-sectional shape of the main body in a thickness direction is a continuous uneven shape in which grooves and bosses are continuously and alternately arranged along a width direction.

8. The roof panel assembly of claim 7, wherein the cross-sectional shape of the main body in the thickness direction is a shape in which a first groove, a boss, and a second groove are sequentially arranged along the width direction,
wherein a convex surface of the boss faces the roof outer panel and is spaced apart from the roof outer panel, and an upper chamber is defined between the roof outer panel and the main body, and
wherein a bottom surface of the grooves defines a frame connecting surface that contacts the rear frame assembly, a convex surface of the boss and the rear frame assembly are spaced apart from each other, and a lower chamber is defined between the rear frame assembly and the boss.

9. The roof panel assembly of claim 8, wherein a sealer is provided at a plurality of positions between an edge of the main body in the width direction and the roof outer panel.

10. The roof panel assembly of claim 3, wherein the connecting member assembly is a sheet metal structural member.

11. The roof panel assembly of claim 10, wherein the main body comprises:
a first main body portion including the frame connecting surface; and
a second main body portion not provided with the frame connecting surface.

12. The roof panel assembly of claim 1, wherein the connecting member assembly is a fork-shaped connecting member.

13. The roof panel assembly of claim 12, wherein the fork-shaped connecting member comprises:
two parallel connecting plates, each being provided with a connecting cross-section connected to the rear cross member assembly; and
a main body connected to one side of each connecting plate opposite to the connecting cross-section and perpendicular to the corresponding connecting plate,
wherein the main body includes a first connecting portion connected to the roof outer panel and two second connecting portions connected to the rear frame assembly, and
wherein each of the second connecting portions is located on one side or the other side of the first connecting portion and is proximate to a lower end of each of the connecting plates.

14. The roof panel assembly of claim 13, wherein:
the rear frame assembly includes a first rear frame and a second rear frame disposed on both sides of the vehicle in a width direction, and the first rear frame and the second rear frame are spaced apart from each other, and
the fork-shaped connecting member is mounted between the first rear frame and the second rear frame.

15. The roof panel assembly of claim 14, wherein:
the roof panel assembly for the vehicle further comprises two side connecting members,
one of the two side connecting members connects the roof outer panel and the first rear frame on one side of the vehicle in the width direction, and
the other of the two side connecting members connects the roof outer panel and the second rear frame on the other side of the vehicle in the width direction.

16. The roof panel assembly of claim 15, wherein the fork-shaped connecting member is integrally formed.

17. The roof panel assembly of claim 13, further comprising a sealer disposed at a plurality of positions between an edge of the connecting member assembly and the roof outer panel.

18. The roof panel assembly of claim 13, wherein the connecting member assembly is a sheet metal structural member.

19. A vehicle comprising:
a sunroof window; and
a roof panel assembly comprising:
a roof outer panel including a sunroof opening, wherein the sunroof window is disposed in the sunroof opening, and
a reinforcement assembly disposed below the roof outer panel and including a cross member assembly and a sunroof frame assembly surrounding an edge of the sunroof opening, wherein the sunroof frame assembly includes a rear frame assembly disposed at a rear portion of the vehicle, wherein the cross member assembly includes a rear cross member assembly disposed at a rear of the rear frame assembly, and
a connecting member assembly connecting the roof outer panel, the rear cross member assembly, and the rear frame assembly, wherein the connecting member assembly includes two L-shaped support connecting members.

20. A vehicle comprising:
a sunroof window; and
a roof panel assembly comprising:
a roof outer panel including a sunroof opening, wherein the sunroof window is disposed in the sunroof opening, and
a reinforcement assembly disposed below the roof outer panel and including a cross member assembly and a sunroof frame assembly surrounding an edge of the sunroof opening, wherein the sunroof frame assembly includes a rear frame assembly disposed at a rear portion of the vehicle, wherein the cross member assembly includes a rear cross member assembly disposed at a rear of the rear frame assembly, and
a connecting member assembly connecting the roof outer panel, the rear cross member assembly, and the rear frame assembly, wherein the connecting member assembly is a fork-shaped connecting member,
wherein the rear frame assembly includes a first rear frame and a second rear frame disposed on both sides of the vehicle in a width direction, and the first rear frame and the second rear frame are spaced apart from each other, and
wherein the fork-shaped connecting member is mounted between the first rear frame and the second rear frame.
